(19) United States
(12) Patent Application Publication
(10) Pub. No.: US 2015/0029346 A1
(43) Pub. Date: Jan. 29, 2015

(54) PHOTO INSPECTION GUIDE FOR VEHICLE AUCTION

(71) Applicants: Joseph Michael Sieger, Barrington, IL (US); Neil Sanders, Chicago, IL (US)

(72) Inventors: Joseph Michael Sieger, Barrington, IL (US); Neil Sanders, Chicago, IL (US)

(73) Assignee: Insurance Auto Auctions, Inc., Westchester, IL (US)

(21) Appl. No.: 13/948,752

(22) Filed: Jul. 23, 2013

(51) Int. Cl. G06F 3/0484; H04N 5/232; H04N 1/00

(52) U.S. Cl. CPC G06F 3/0484; H04N 1/00161; H04N 5/23222
USPC 348/207.1; 715/771; 348/333.03

(57) ABSTRACT

A system and method for evaluating quality of photographs of an item, such as a damaged vehicle for auction, includes displaying a predetermined set of views of the vehicle in a predetermined arrangement on a display screen for viewing by a reviewer. The predetermined views include an overlay of an alignment guide on some of the photographs. The reviewer enters a rating for the photographs of the set as a pass or fail rating, wherein the fail rating includes one of a plurality of fail ratings identifying a problem with at least one of the photographs. Following entry of a rating by the reviewer, a next set of photographs of a next item is displayed in the same predetermined arrangement as for the first item. Photographs receiving a fail rating are identified for re-taking of the photographs of the item. Overlays are provided for alignment of the object for photographers.

### BACKGROUND OF THE INVENTION

1. Field of the Invention

The present invention relates generally to a method and system for evaluating photographs and, more specifically, to a method and system for evaluating photographs of vehicles.

2. Description of the Related Art

When an automobile or other vehicle is damaged as a result of an accident or natural disaster, the damage may be extensive enough that the title of the vehicle is transferred to the insurance company in return for an insurance settlement to the vehicle owner. Once the vehicle title is transferred to the insurance company, the insurance company typically uses an auction service to auction off the damaged vehicle to a salvage company or other entity. Auction services present the damaged vehicles that are available for auction via electronic information that includes photographs of the damaged vehicle and information about the vehicle. A potential buyer of the vehicle searches through a database of vehicles for a desired vehicle and reviews the electronic information provided by the auction service.

The completeness and clarity of the electronic information about the vehicle may determine whether interested buyers are able to locate a desired vehicle. Once the potential buyer has located the information on a vehicle, the quality of the information may determine whether the potential buyer will pursue the purchase of the vehicle and/or may determine the price offered to the auction service by the potential buyer.

Auction services hire people or a service to obtain the electronic information on the vehicles. The damaged vehicles are photographed so that the photographs may be presented to potential buyers of the vehicles.

### SUMMARY

A system and method are provided for reviewing the photographs of vehicles or other subjects to determine whether the photographs clearly depict the vehicles or other subjects to a potential buyer. The photographs are reviewed with reference to photographs that have desirable traits and/or photographs that have undesirable traits. The photographs are reviewed to determine if the photographs of a standardized set of photographs are present. The photographs are rated by the reviewer for completeness and/or clarity, and problems with the photographs may be identified. To assist the reviewer, an overlay may be provided on at least some of the photographs for aid in determining whether the subject shown in the photographs corresponds with a desired placement of the subject.

A system and method are provided for presenting the photographs to a reviewer for review and grading. The system and method provides quick and simple means for the reviewer to examine the photographs of a set, and to enter a grade or rating for the photographs. Upon entry of a grade or rating, the system and method presents a next set of photographs to the reviewer for consideration.

The system and method provides a means for review and grading of large numbers of photographs by one or more reviewers. The performance of the reviewer may be measured and/or compared to the performance of other reviewers. The results of the review may be used to re-take selected photographs, to rate a photographer or group of photographers, to make a comparison between photograph ratings and sale price, or may be used for other reasons.

The overlays used by the reviewers may also be provided to the photographers for use when the photographs are being taken. In one example, an app or other program is operational with a camera to provide an overlay for use by the photographer.

### BRIEF DESCRIPTION OF THE DRAWINGS

FIG. 1 is a screen shot of a photo inspection program according to the principles of the present invention;

FIG. 2 is a listing of key commands for a user to interact with the photo inspection program;

FIG. 3 is an example of a photograph of a vehicle that is acceptable although there is a person shown in the background;

FIG. 4 is an example of a photograph of a vehicle that is acceptable although snow is on the vehicle;

FIG. 5 is an example of a photograph of a vehicle that is acceptable although there is a person near the vehicle;

FIG. 6 is an example of a photograph of a vehicle that is acceptable although there is glare on a portion of the vehicle;

FIG. 7 is an example of a photograph of a vehicle that is not acceptable as a result of glare on a portion of the vehicle;

FIG. 8 is an example of a photograph of a vehicle that is not acceptable as a result of glare on a portion of the vehicle;

FIG. 9 is an example of a photograph of a vehicle that is acceptable although a shadow is on the vehicle;

FIG. 10 is an example of a photograph of a vehicle that is not acceptable as a result of a shadow on a portion of the vehicle;

FIG. 11 is an example of a photograph of a vehicle that is not acceptable as a result of darkness;

FIG. 12 is an example of a photograph of a vehicle that is not acceptable as a result of being out of focus;

FIG. 13 is an example of a photograph of a vehicle that is not acceptable as a result of being under-exposed;

FIG. 14 is an example of a photograph of a vehicle that is not acceptable as a result of being under-exposed;

FIG. 15 is an example of a photograph of a vehicle that is not acceptable as a result of dirt on the lens;

FIG. 16 is an example of a photograph of a vehicle that is not acceptable as a result of a portion of the vehicle being not visible in the frame;

FIG. 17 is an example of a photograph of a vehicle that is not acceptable as a result of being out of focus;

FIG. 18 is an example of a photograph of a vehicle that is has a parking space overlay, the photo being acceptable;

FIG. 19 is an example of a photograph of a vehicle with a parking space overlay, the photo being not acceptable as a result of poor alignment of the vehicle;

FIG. 20 is an example of a photograph of a vehicle with a parking space overlay, the photo being acceptable;

FIG. 21 is an example of a photograph of a vehicle with a parking space overlay, the photo being unacceptable;

FIG. 22 is an example of a photograph of a vehicle that is not acceptable;

FIG. 23 is an example of a photograph of a vehicle that is not acceptable;

FIG. 24 is an example of a photograph of a vehicle that is not acceptable;

FIG. 25 is an example of a photograph of a vehicle that is not acceptable;

FIG. 26 is an example of a photograph of a vehicle that is not acceptable;

FIG. 27 is an example of a photograph of a vehicle that is acceptable;

FIG. 28 is an example of a photograph of a vehicle that is not acceptable;

FIG. 29 is an example of a photograph of a vehicle that is not acceptable;

FIG. 30 is an example of a photograph of a vehicle that is not acceptable;

FIG. 31 is an example of a graphical message relating to a vehicle that is not acceptable;

FIG. 31 is an example of a graphical message relating to a vehicle that is not acceptable;

FIG. 32 is an example of a graphical message relating to a vehicle that is not acceptable;

FIG. 33 is an example of a graphical message relating to a vehicle that is not acceptable;

FIG. 34 is a screen shot showing photos of a vehicle where some of the standard images are missing;

FIG. 35 is a screen shot showing photos of a vehicle where non-standard images are present;

FIG. 36 is a screen shot showing photos of a vehicle showing selection of rating keys;

FIG. 37 is a screen shot showing rating keys that may be used by a user using a left hand;

FIG. 38 is a screen shot showing rating keys that may be used by a user using a right hand;

FIG. 39 is a schematic diagram of a system for rating photographs of vehicles;

FIG. 40 is a screen shot of a camera overlay app for use in taking photographs;

FIG. 41 is a screen shot of a camera display showing an overlay for alignment with a vehicle and a level indicator;

FIG. 42 if a screen shot of a camera display showing the overlay for alignment with a vehicle and an indicator of an out-of-level condition;

FIG. 43 is a photograph of a vehicle taken using the overlay of FIG. 41;

FIG. 44 is a screen shot of the photograph of FIG. 43 in the overlay app of FIG. 40;

FIG. 45 is a screen shot of a report to a reviewer; and

FIG. 46 is a screen shot of the reviewer report reporting compensation guidelines.

### DETAILED DESCRIPTION OF THE PREFERRED EMBODIMENTS

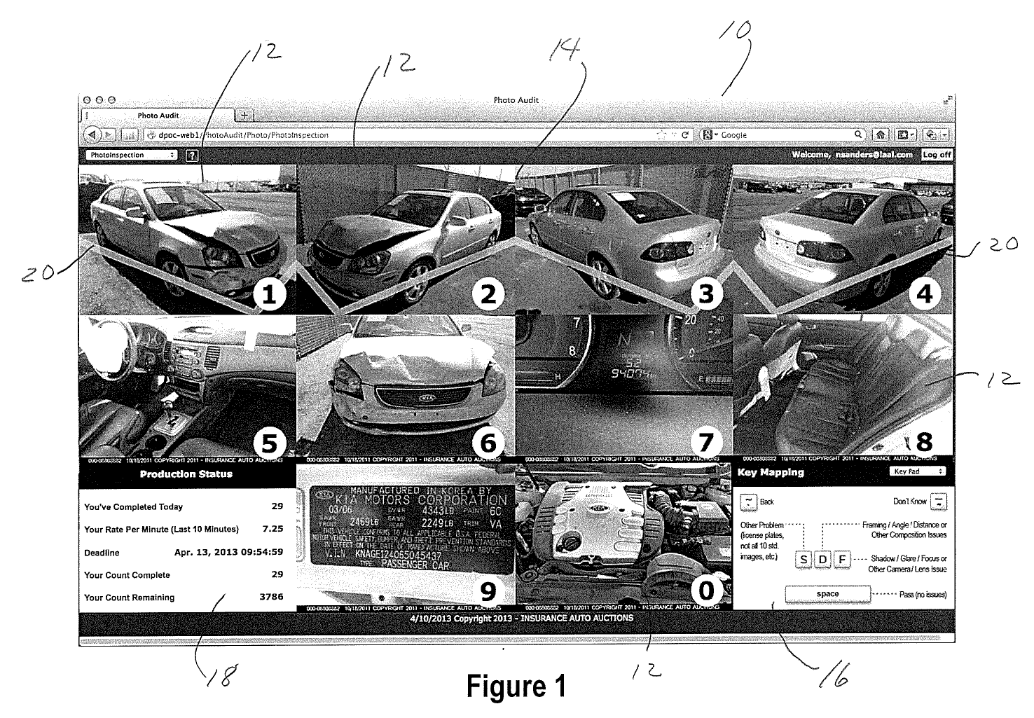

Referring first to FIG. 1, a screen shot 10 from a computer device, mobile device, tablet, video or television screen, or other device shows an arrangement of photographs 12 of a subject, such as a damaged vehicle. The photographs 12 show ten different views of the same vehicle and are numbered 1-9 plus 0 (1-10) in a matrix or grid 14. The photographs 12 have been obtained in preparation for selling the vehicle at an auction. A vehicle which is to be auctioned is photographed by a photographer and the resulting photographs are provided to a database or other computer readable storage medium. The photographs are linked to information about the vehicle depicted, such as a reference number, stock number, VIN (vehicle identification number), or other number or code.

The photographs are taken of particular portions of the vehicle from particular directions with the objective of showing sufficient views of the vehicle that a potential buyer of the vehicle at auction may make a judgment about purchasing the vehicle. A limited number of views is desired instead of a large number of views of the vehicle, which would be burdensome to review and would require paging through multiple screens to view the images at an adequate size to see the details. In the illustrated screen shot 10, ten views in the grid 14 have been determined to adequately depict the vehicle on a single screen. Of course, other numbers of views may be provided.

The potential purchaser of the vehicle may view the photographs, either individually, in a grid, or other arrangement that shows some or all available views of the vehicle and may select, such as with a mouse or other pointer device, any of the views for enlargement. The buyer grid of photographs may be similar to that used by the reviewer, or the buyer arrangement may be different. If one or more of the photographs shown to the buyer are not clear, or if a photograph does not depict a portion of the vehicle well, or at all, the potential purchaser may not be able to determine the condition of undamaged parts of the damaged vehicle. If the potential buyer is not able to determine the condition of the vehicle or of a portion of the vehicle from the photographs, the potential buyer may not have an interest in purchasing the vehicle or may not bid as high of a price for the vehicle. It is therefore beneficial to the seller of the damaged vehicle as well as to the potential buyer of the vehicle that the photographs be clear, show all the desired parts and views of the vehicle, and lack blocking or distracting elements.

An auction service handling large numbers of vehicles for auction would benefit from understanding how well the vehicles are shown in the photographs. As such, after the photographs have been taken and after they are provided to the storage media in a way that enables the photographs to be depicted in the grid 14, they are reviewed by a photo quality reviewer. The screen shot 10 of FIG. 1 shows a grid 14 of photographs for review by the reviewer. The reviewer examines the photographs and rates the photographs as to whether they meet the criteria of, for example, being clear and adequately showing all of the desired parts of the vehicle. The reviewer reports the rating of the photographs by selecting keys on a keyboard, for example.

The keystrokes for entering ratings are shown in a screen portion 16 of the grid 14 entitled key mapping. The key mapping screen 16 shows the reviewer which keys of a keyboard to press to enter a rating for the photographs 12. The key mapping 16 is set up for quick entry of a rating for each grid 14. In the illustrated example, the keys S, D and F and the space bar are provided for entering ratings. These keys lie under the thumb and first three fingers of the left hand of a person resting their hand at the standard typing position on a qwerty keyboard. This enables the reviewer to spend less time entering a rating for a grid and thus able to review more grids 14 in a given time.

All of the photographs of the grid 14 are rated with a single rating, regardless of whether only one photograph fails or passes the rating or whether several photographs in the grid fail or pass the rating. It is contemplated that the photographs may be rated individually, or in other groupings.

The reviewer is assigned vehicle photograph grids 14 to review. In some instances, the reviewer is assigned a predetermined number of grids 14 to review as a project or task. A production status portion 18 of the grid 14 shows the reviewer the statistics on the grid review project. For example, the production status portion 18 of the illustrated example reports the number of grids reviewed by the reviewer today, the rate of grids reviewed per minute, the deadline for the review project, the count of grids completed so far in the project, and the count of grids remaining for review in the assigned project.

The photographs 12 in the grid 14 are arranged for quick review by the reviewer, with each view of the vehicle or other subject at the same orientation in the same position in the grid each time a grid of photographs is presented to the reviewer. It is foreseen that the arrangement of the views may be customized by the reviewer or changed periodically by the system, such as to alleviate reviewer fatigue.

The reviewer's screen includes an additional feature that may not be shown in the views presented to potential buyers. Virtual parking spaces 20 are overlaid on the photographs in some views. The views of the damaged vehicle in the illustrated grid 14 include: 1) right front corner or passenger fender, 2) left front corner or driver fender, 3) left rear corner, 4) right rear corner or driver quarter panel, 5) interior showing dashboard and front seats or passenger inside, 6) damage area, which is in this example is front bumper, 7) instrument cluster detail including odometer, 8) interior showing rear seats, 9) vehicle manufacturer's plate or sticker, and 10) engine. The virtual parking space overlay 20 is provided in views 1)-4). Other overlays are of course possible. In one example, the virtual parking space lines may be turned on and off by the reviewer, to “blink” the lines.

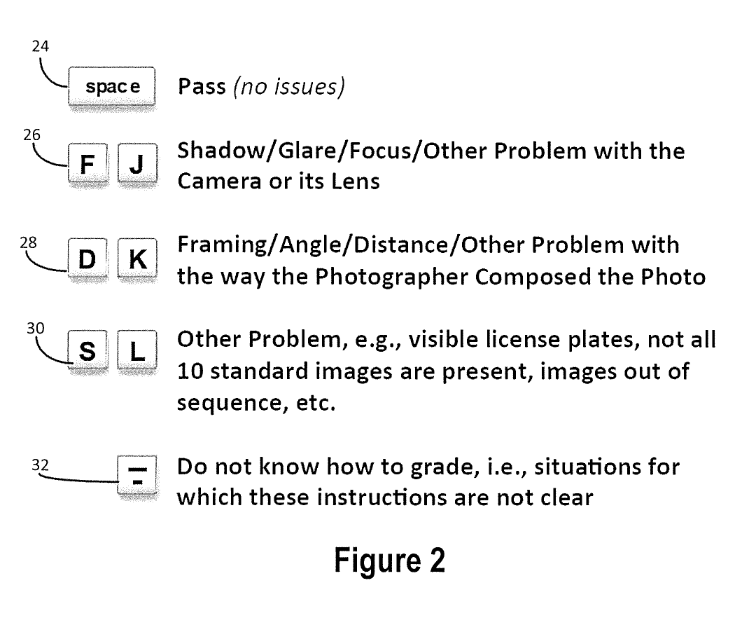

The keystrokes used to enter ratings of the photographs may be varied as desired by the reviewer. Different levels of information may be gathered by providing more or fewer possible rating values for the reviewer to choose from. At a base level, the photographs may be rated on a pass/fail basis with only two possible choices in the rating. FIG. 2 shows an example of a keystroke rating arrangement that permits ratings to be entered relating to three classes of possible problems with the photographs.

The keys for the rating entry are selected so that either hand may be used by the reviewer in rating the photographs. In particular, the reviewer who reviews the photographs and sees no issues with the photographs may select a pass command 24 using the space bar of the user's keyboard using either hand. If the reviewer sees that the photographs have a shadow, glare, focus, or other problem with the camera or lens, the reviewer selects the shadow and glare command 26 using either the “F” key or the “J” key of the users keyboard, depending on the hand being used. For photographs that have issues relating to framing of the photograph, the angle at which the photograph was taken, the distance from the subject, or other problem with the way the photographer composed the photograph, the reviewer selects the composition command 28 using the “D” or the “K” keys, depending on the hand used. If the reviewer determines that there are other problems with the photographs such as that a license plate is visible in the photograph, that not all ten of the standard images are present, or that the images are presented out of sequence, the reviewer selects the other problems command 30 using the “S” or “L” keys, depending on the hand used. If the reviewer is not able to determine a rating for the photographs, for example where the instructions regarding the rating of the photographs are not clear, the user may select the underscore and hyphen key 32. There are thus five possible values to assign to the photographs, each entered by tapping a single key.

The reviewer is to use the keystroke commands to evaluate the set of vehicle images as a whole in this embodiment. A set of images in the grid 14 may have more than one issue, such as two photographs with issues of glare and another image with the vehicle at the wrong angle. The most obvious or severe issue is to be selected when grading the photographs.

The keys 24-32 are selected to permit the reviewer to enter a rating for the photographs without moving the user's hand from a stationary position over the keyboard. This facilitates rapid review of the photographs by the user. The user may select other key combinations for entering the ratings, for example, if the reviewer finds other key combinations that work better for that particular reviewer.

Where large numbers of images require review, several reviewers may be assigned to the review project. The reviewers may be employees of the company, may be part time employees, or contract employees. The reviewer can perform the review task either at an office or from home. The photo quality review work can be performed by stay-at-home mothers, disabled persons, students or others seeking work that does not require set hours or travel to an office or factory. The reviewers may work on the photo quality review projects as freelance employees, and may be known as freelancers.

The photograph quality review process may include additional levels of ratings for the photos where additional information is needed. For example, it may be desirable to rate the photos separately for glare, shadow or focus issues using different keystrokes for each rating. It may be possible to rate each of the ten standard photographs individually in a pass/fail rating or to rate each photograph by issue, such as shadow, framing, etc. The more issues rated by the reviewers, the more information that is available about the photographs. Fewer issues being rated results in less information. In a preferred embodiment, a grouping image problems into three or four groups as shown for example in FIG. 2 has been found to provide a balance between levels of information required compared to overhead to obtain the review results. The outcome of the review according to one embodiment is to provide an improved empirical result—a higher average sales price for vehicles for which the photographs received a passing grade. In some tests, vehicles presented in photographs that have received a passing grade have been shown to receive a higher sales price, on average. The price may be as much as three percent higher where only passing grade photographs are used in the auctioned vehicles compared to photographs that have not been reviewed.

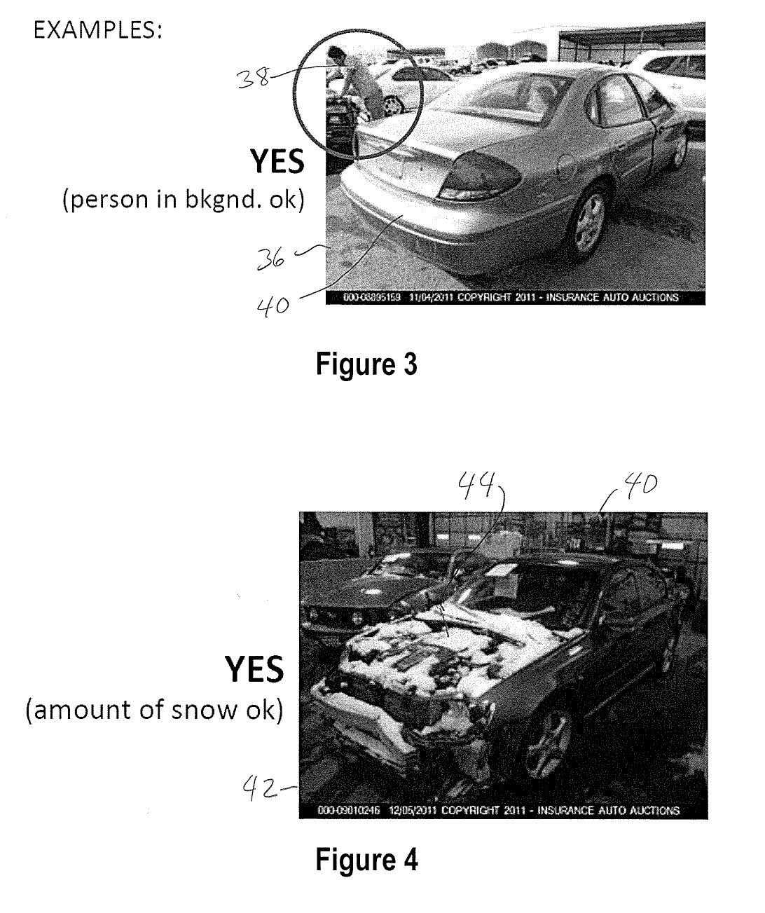

The following provides an overview of the criteria to be used by the reviewers in rating the vehicle photographs in one embodiment. These photographs may be used to train reviewers as to what is an acceptable photograph and what is an unacceptable photograph. In FIG. 3, a photograph 36 of a vehicle 40 is shown. The vehicle 40 is clearly depicted and well framed. A person 38 appears in the background behind the vehicle 40. The person 38 does not block the view of the vehicle 40 so the reviewer should rate this photograph 36 as acceptable with a pass keystroke 24. People or other things in the background or a reflection of the photographer may be graded as a pass if these things do not affect the ability to see the damaged and undamaged areas of the vehicle.

In FIG. 4 a photograph 42 shows a vehicle 40 in a front view in which the hood appears to be missing. Snow has fallen, much of which has been removed from the vehicle 40 with a small amount remaining in and around the engine compartment 44. The damage to the front of the vehicle 40 and the presence of the engine in the car are apparent in spite of the snow. The reviewer should rate this photograph as acceptable with a pass keystroke 24. Snow need not be completely removed from the vehicle if it does not adversely affect the ability to see the damage and undamaged areas of the vehicle.

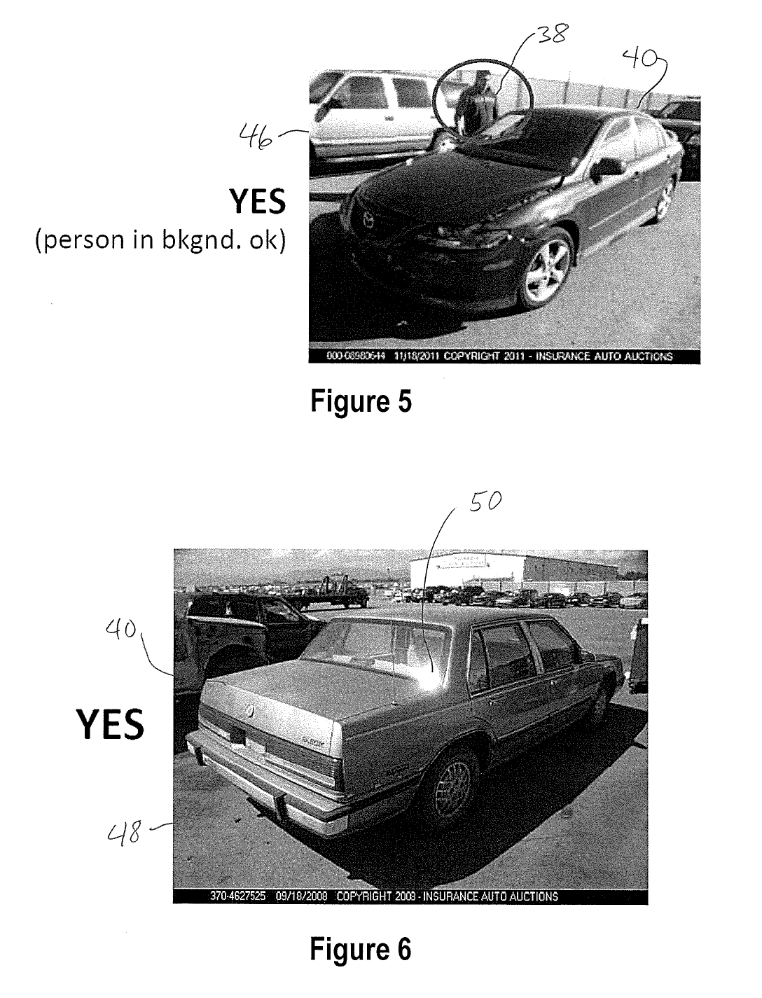

FIG. 5 shows a vehicle 40 with a person 38 in the background of the photograph 46. The reviewer should rate this photograph 36 as acceptable. FIG. 6 is a photograph 48 of a vehicle 40 in which sunlight results in a small area of glare 50 on the rear window of the vehicle. The area of glare 50 is small and does not obscure significant structural aspects of the vehicle 40, so the reviewer should rate this photograph 48 as acceptable with a pass keystroke 24.

Other guidelines to the reviewers are that the parts of the vehicle that are entirely damaged may be outside the frame of the photograph yet the photograph may receive a pass, as long as the photograph is taken so that it is obvious to the viewer that the unseen parts are damaged. Trash should be removed from the vehicle and personal items should be bundled prior to taking the photograph to obtain a pass for the image.

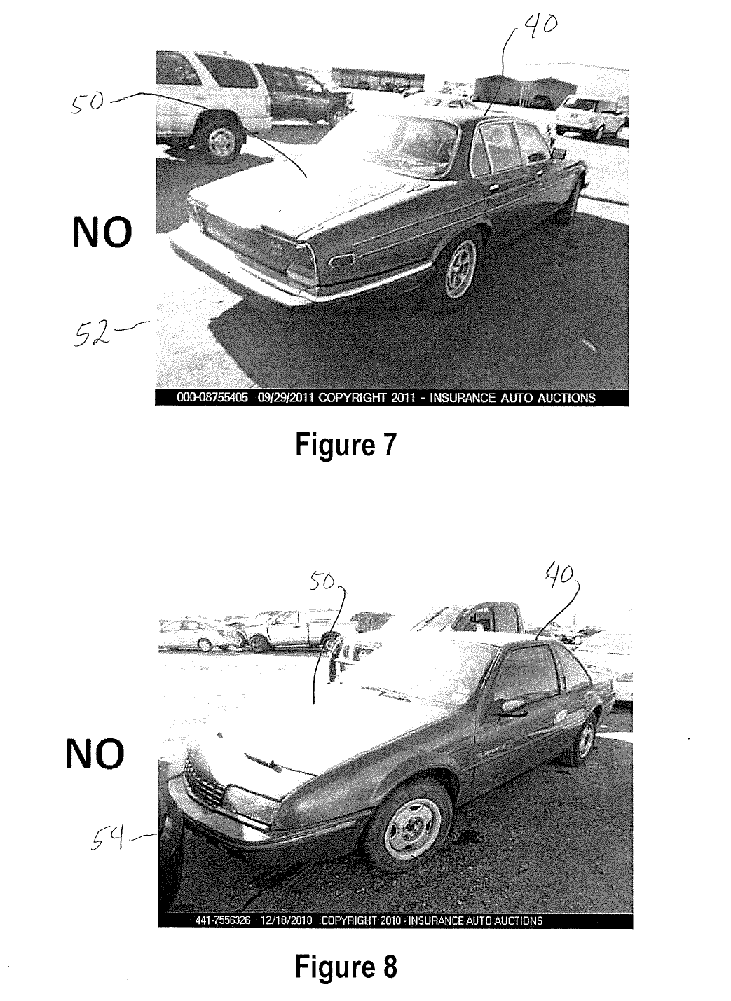

For comparison, FIG. 7 is a photograph 52 that shows a vehicle 40 in which the entire rear portion of the vehicle including the trunk lid, rear window and rear bumper are hidden by glare 50 caused by the bright sunlight. The viewer of this photograph 52 cannot see sufficient detail in the glare 50 areas to determine if the hidden parts have sustained damage or not. The reviewer should rate this photograph 52 as fail, for example using the shadow and glare command 26.

A similar issue is apparent in the photograph 54 in FIG. 8. The hood and windshield of the vehicle 40 are hidden in glare such that a viewer cannot determine if these areas are damaged or not. The reviewer should rate this photograph 54 as fail using the shadow and glare command 26. The glare classification also includes images in which portions of the photograph are overexposed as a result of an improper setting on the camera or excess brightness as a result of high contrast in the image beyond what can be accurately recorded by the sensor of the camera. Images should be rated as unacceptable if the photograph has glare from the sun, from reflection from shiny parts such as chrome or glass, or glare caused by the camera flash.

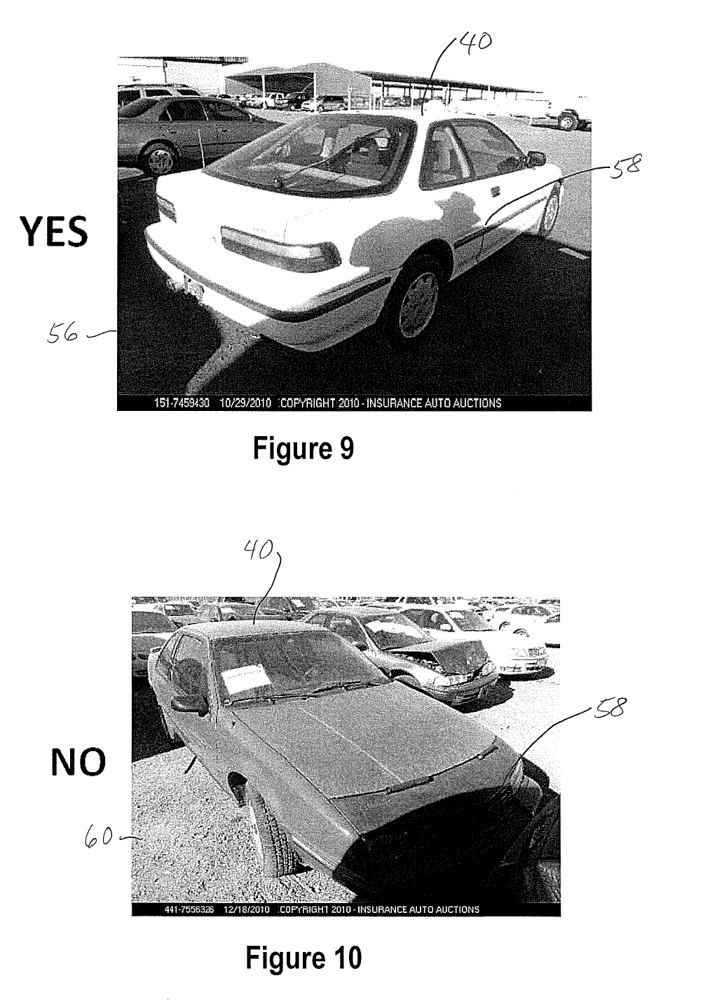

FIG. 9 is a photograph 56 of a vehicle 40 that is well lit without glare but does have a shadow 58 that falls on a part of the vehicle 40. The shadow 58 is not particularly dark and the parts of the vehicle 40 in the shadow 58 are apparent to the viewer. The shadow 58 only covers a small part of the vehicle 40. This image should receive a passing grade.

FIG. 10 is a photograph 60 of a vehicle 40 with a shadow 58 that falls across the grill and front bumper of the vehicle 40. The shadow is dark and much of the detail in the shadowed area is not visible to the viewer. The reviewer should rate the photograph 60 as a fail using keystroke 26. If the shadowed areas obscure details in the image the image should be rated as unacceptable.

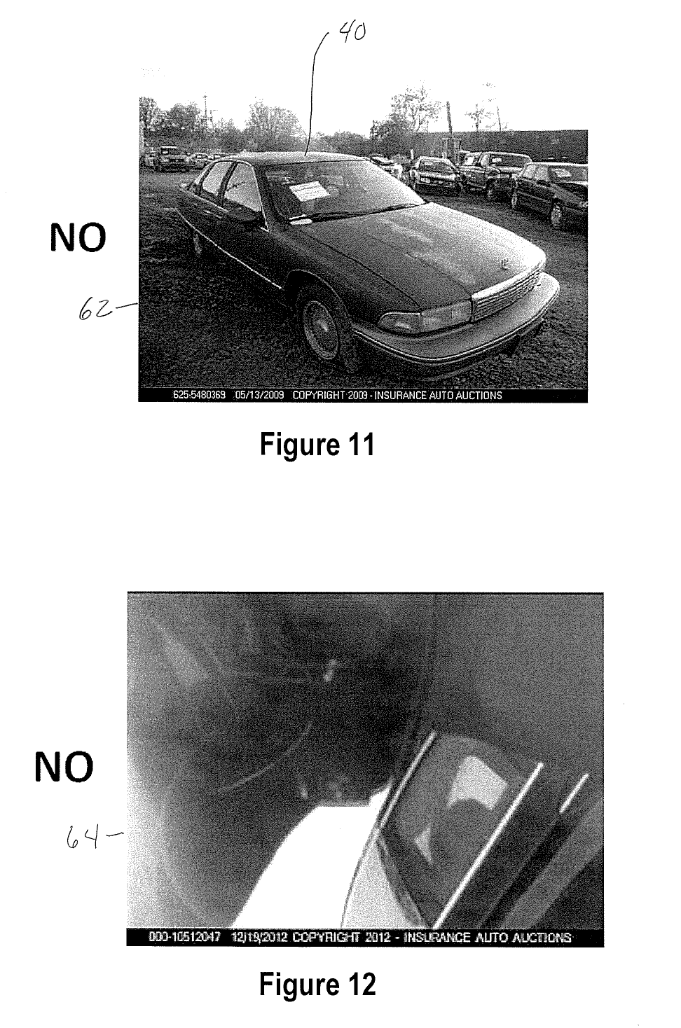

FIG. 11 is a photograph 62 of a vehicle 40 taken in a low light situation, for example after sunset. Darkness has resulted in the contrast of the photograph 62 being low, with little or no color being apparent in the photograph, and with details of the vehicle 40 not being clear. The photograph 62 should be rated a fail by the reviewer, such as using keystroke 26.

In FIG. 12 a photograph 64 is shown in which the focus and framing are such that it is not clear to the viewer what part of the vehicle is being shown. The photograph 64 may not correspond to any of the standard views. This photograph 64 should fail by selecting the keystroke 26. Also, the image is hazy, which may be the result of dirt or debris on the camera lens, which may results in a keystroke 26 indication of unacceptability.

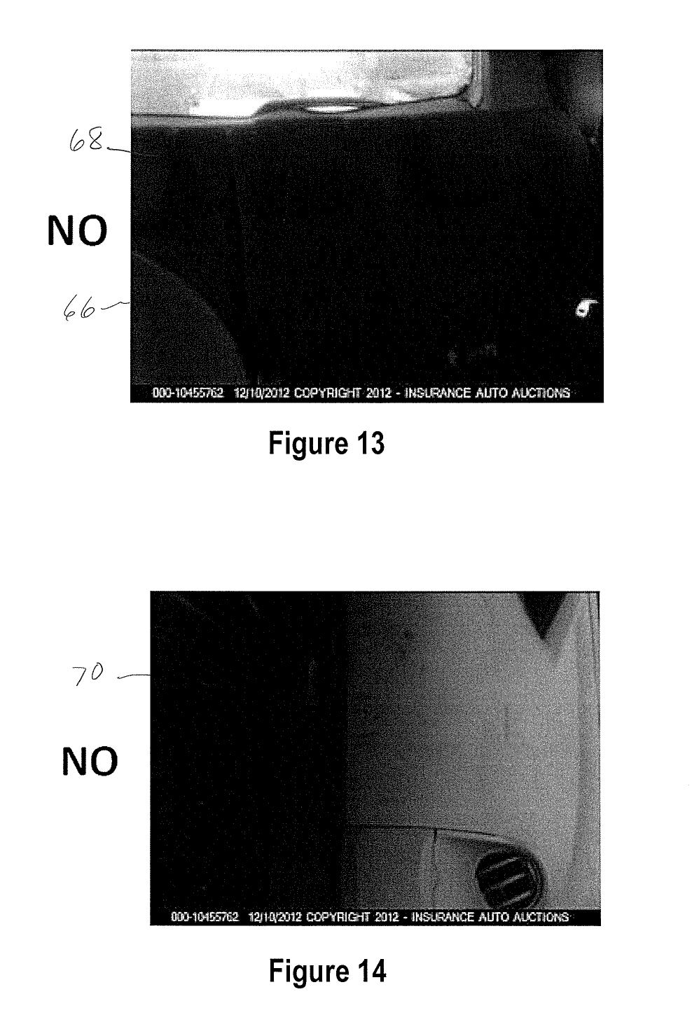

FIG. 13 is a photograph 66 of a backseat 68 of a vehicle. This interior shot is poorly lit so that the photograph is dark with little detail apparent to the viewer. The reviewer should rate the photograph 66 as a fail using keystroke 26.

FIG. 14 is a photograph 70 that may show a portion of a vehicle dashboard. What is being shown is not clear and the photograph may not correspond with one of the ten standard images. The photograph 70 should receive a fail, such as under keystroke 26.

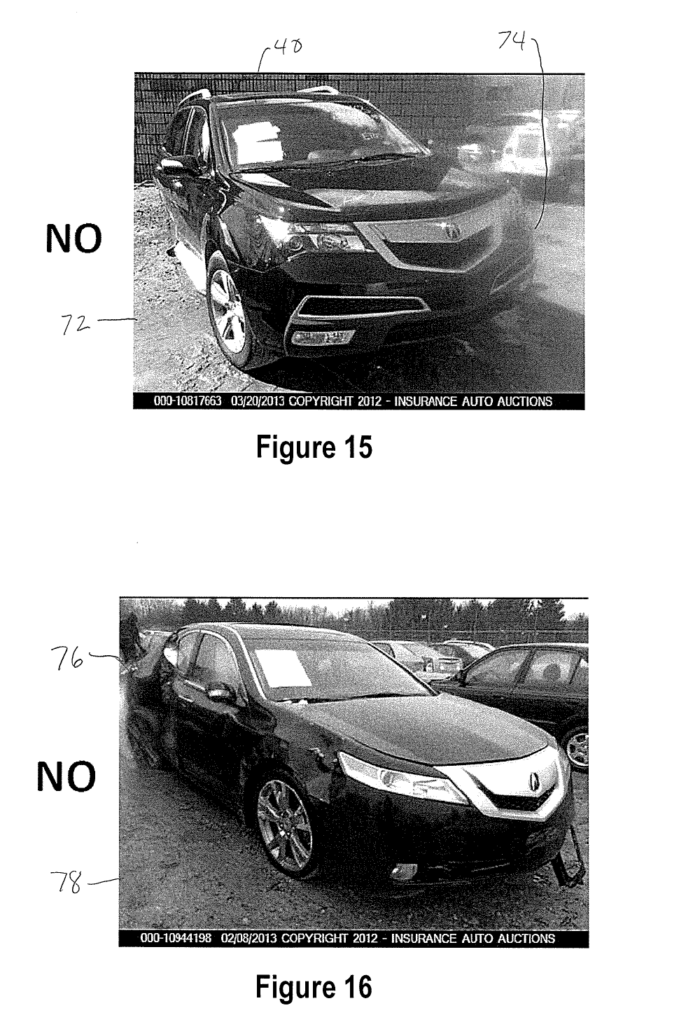

With reference to FIG. 15, a photograph 72 of a vehicle 40 in which the right hand portion 74 of the photograph is hazy and blurred. Dirt or other problems with the camera lens may have caused the poor quality photograph. The photograph 72 should be graded as fa fail under keystroke 26.

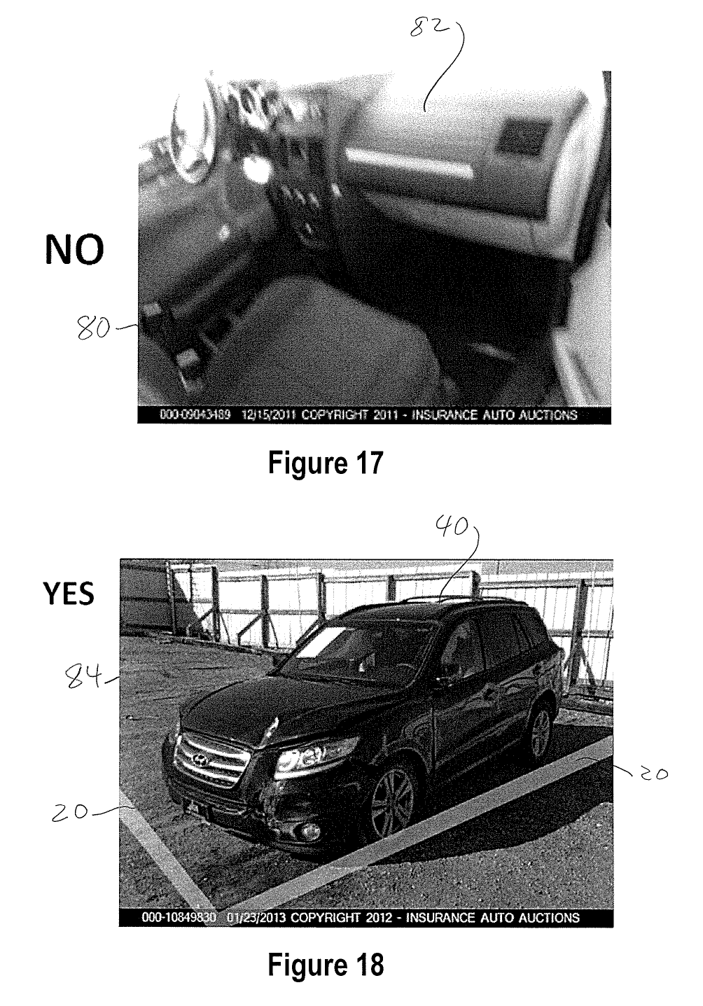

In FIG. 16, the left hand portion 76 of the photograph 78 is hazy and blurred. The photograph should be rejected by keystroke 26.

FIG. 17 is a photograph 80 of the dashboard and instrument panel 82 of the vehicle 40 from the passenger seat. The photograph is blurry either from being poorly focused or as a result of camera movement as the photograph was being taken. The blurry photo inhibits seeing the vehicle parts that are undamaged and distinguishing from those that are damaged. The photograph 80 should receive an unacceptable rating from the reviewer using the keystroke 26.

Framing and angle issues are addressed by providing the virtual parking space lines 20 overlaid on the photograph. For example, a photograph 84 in FIG. 18 shows the driver fender view of a vehicle 40. To best show the driver side fender, front, and left side of the vehicle, a preferred angle for depicting the vehicle in the photograph has been determined and a preferred placement of the vehicle within the image frame is also determined. The parking space overlay provides the guidelines for the reviewer to determine whether the image complies with the preferred orientation.

The reviewer is to determine whether portions of the vehicle appear or not in the field of view of the image, for example, if portions of the vehicle are cut off or out of the frame. According to one embodiment, the corners of the vehicle should generally be aligned with one-third marks in the frame. The image should not be tilted, instead the vehicle should appear horizontal in the image. The photographer's hand or thumb, or a camera strap or other object should not appear in the image. Further, other cars or vehicles should not block the view of the vehicle to be shown. The viewer should be able to tell from the photographs what area of the vehicle are left undamaged, the extent of and the nature of the damage to the vehicle. The viewer should be able to decide from the view expected to be shown in the ten standard photographs if a part of the vehicle has damage, if it was ever damaged, if it is not original equipment, and if it has wear. Other factors may be determined from the images as well.

The reviewer should not pass a grid 14 of photographs when there is a part of the vehicle for which the foregoing problems is true. The vehicle should not pass if there is no visual information from which to determine if the evaluation criteria are true, particularly if it is because there is something wrong with the way the photographs were taken. On the other hand, a photograph may be acceptable if a part that is damaged is partially out of the frame. The parts that are not damaged must be entirely within the image frame. This is so because in many instances the buyer of the vehicle is purchasing the vehicle for re-use of the undamaged parts.

Referring back to FIG. 18, the virtual parking space is overlaid on the vehicle image 84. A judgment is made as to whether the vehicle 40 is located within the virtual parking space. In the case of the photograph 84, the vehicle 40 is generally within the virtual parking space, generally at the desired angle and orientation relative to the image frame, and so the image should be given a passing grade using the keystroke 24.

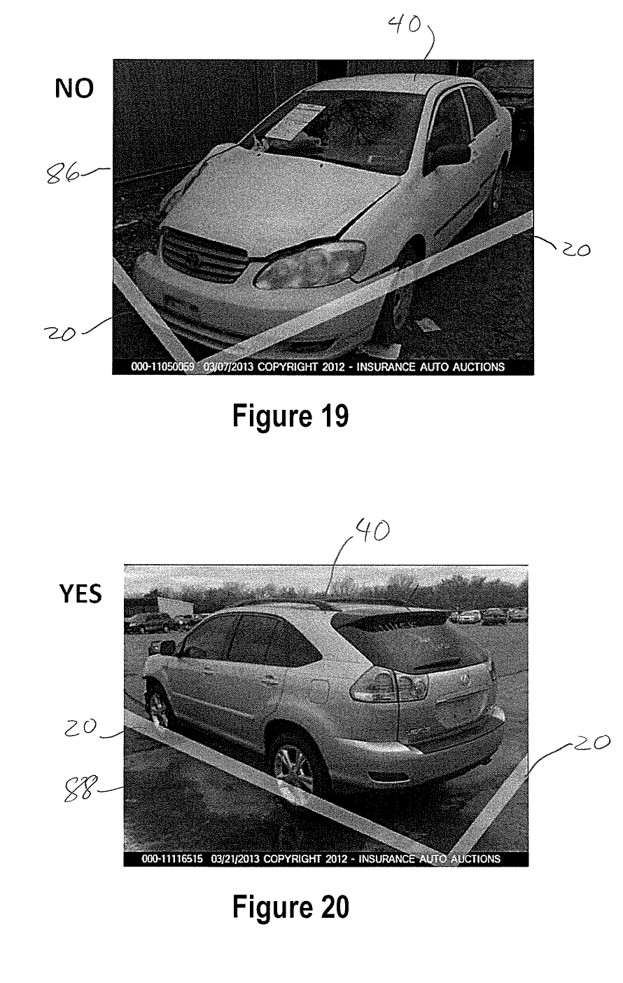

In FIG. 19, the vehicle 40 is at a considerably different angle within the image frame 86 than the desired angle. The virtual parking space lines 20 that are overlaid on the image show the desired vehicle location, which does not align with the vehicle position shown. The amount of misalignment between the virtual parking space lines and the vehicle shown in the image is sufficient that the reviewer should rate this image as a fail using the framing and angle command 28.

FIG. 20 shows the driver side rear quarter panel view 88 of a vehicle 40 on which the virtual parking space lines 20 have been overlaid. The vehicle 40 is generally aligned with the virtual parking space lines 20. The photograph 88 should be giving a passing grade 24 by the reviewer.

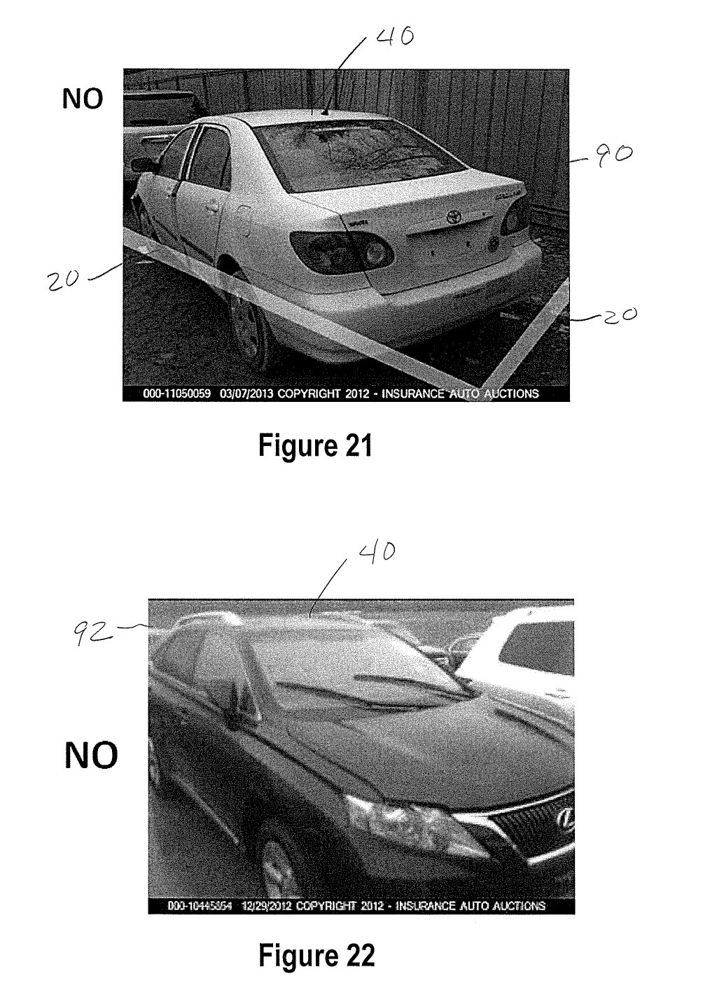

For comparison purposes, FIG. 21 is a photograph 90 of the same portion of the vehicle 40, the driver side rear quarter panel, overlaid with the virtual parking space lines 20. The vehicle 40 is poorly aligned in the image compared to the desired positioning. The reviewer should rate this image as failing for framing and angle issues using the command 28.

With reference to FIG. 22, a vehicle 40 is shown in a photograph 92. The front bumper, portions of both fenders and the passenger rear quarter panel are all cut off by the edges of the image 92. This image fails on framing and angle issues using command 28 even without the need for a virtual parking space overlay. Of course, other arrangements of virtual parking spaces, or product alignment overlays or other guidelines, is contemplated and within the scope of this invention.

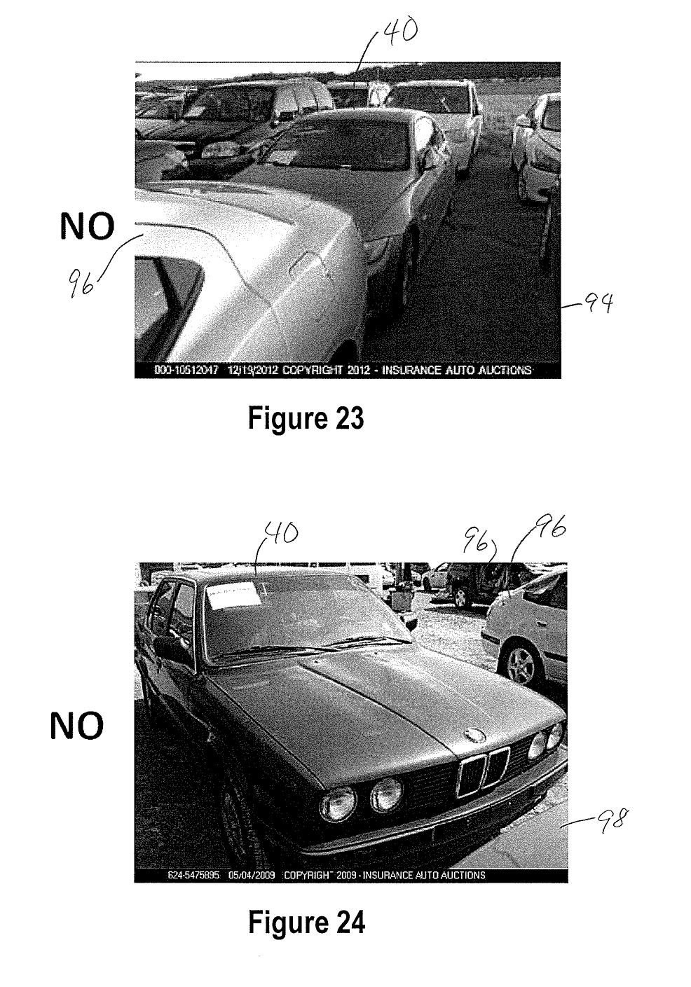

In large scale disasters such as floods or storms, a large number of vehicles are damaged and available for auction. Some large disasters result in thousands of vehicles being damaged, which are collected at certain locations for processing and temporary storage. This large volume of vehicles leads to crowding in the vehicle processing and storage lots, which makes photographing the vehicles according to the standard alignments a particular challenge. In FIG. 23, the vehicle 40 has been photographed in an image 94 but a portion of another vehicle 96 is in the way of a significant portion of the vehicle 40 that is targeted in this photograph. The photograph 94 should be rated as a fail using the framing, angle, distance, or other problems with the way the photographer composed the photograph command 28.

The photographer may have attempted to compensate for a crowded vehicle lot in the photo 98 of FIG. 24. Other vehicles 96 can be seen in the background. However, the photographer took the photograph 98 too close to the vehicle 40, resulting in portions of the front bumper and rear quarter panel of the vehicle being cut off. These parts of the vehicle 40 may be important to a salvage service which may not be able to tell if the parts are undamaged or original to the vehicle 40. As such, the reviewer should rate this image 98 as a fail under the framing and distance command 28.

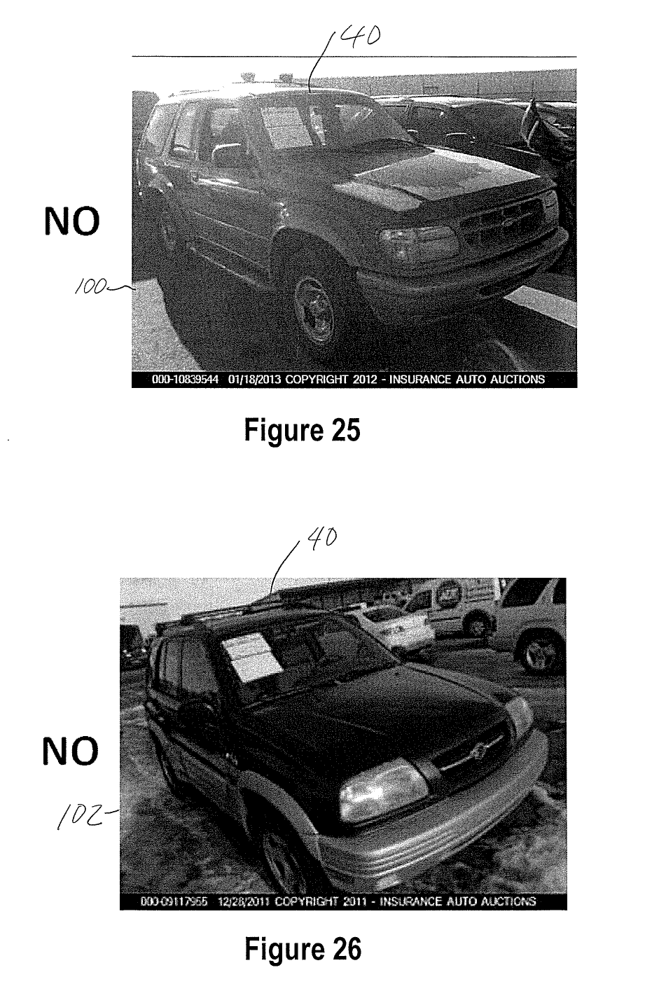

Turning to FIG. 25, the vehicle 40 is shown within the image 100 but the rear quarter panel of the vehicle is very close to the edge of the image 100. This image should be rated as a fail for framing issues using command 28. The angle of the sunlight for this photograph is into the camera lens resulting in much of this view being in shadow with the vehicle appearing washed out due to the sunlight falling on the camera lens. This may be another reason to reject this image 100.

For FIG. 26, the vehicle 40 in image 102 is not horizontal; the image is tilted. The tilted image should result in the reviewer rejecting the image 102 using the framing and angle command 28.

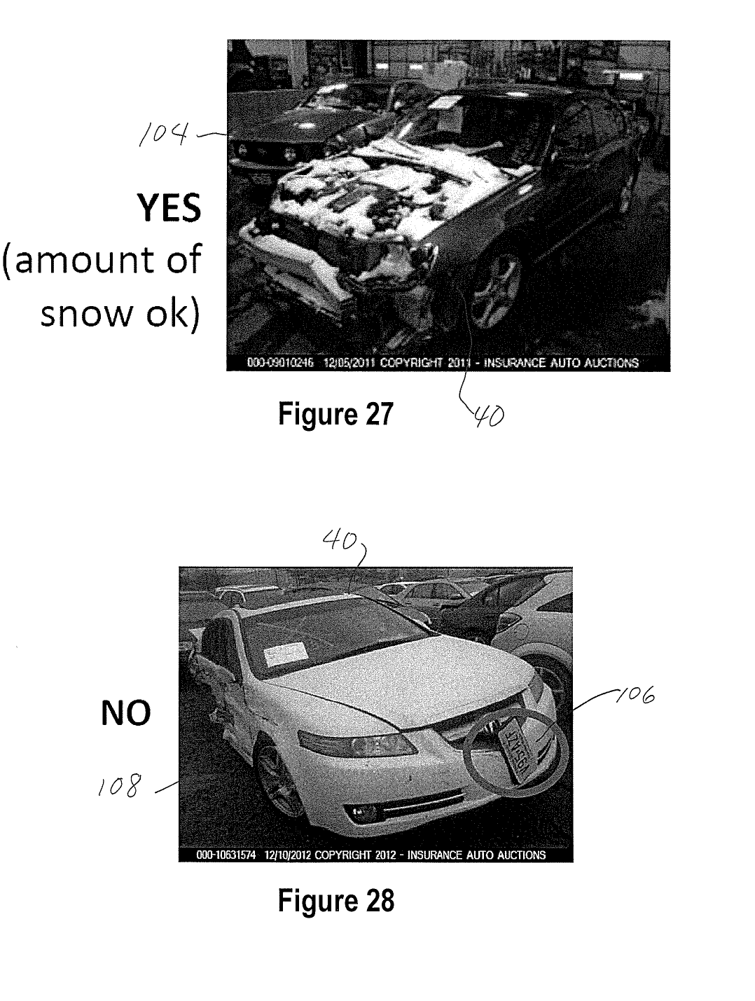

FIG. 27 depicts the vehicle 40 with snow on the vehicle, although most of the snow has been cleared from the body of the vehicle. The image 104 is acceptable and should be so indicated by the reviewer.

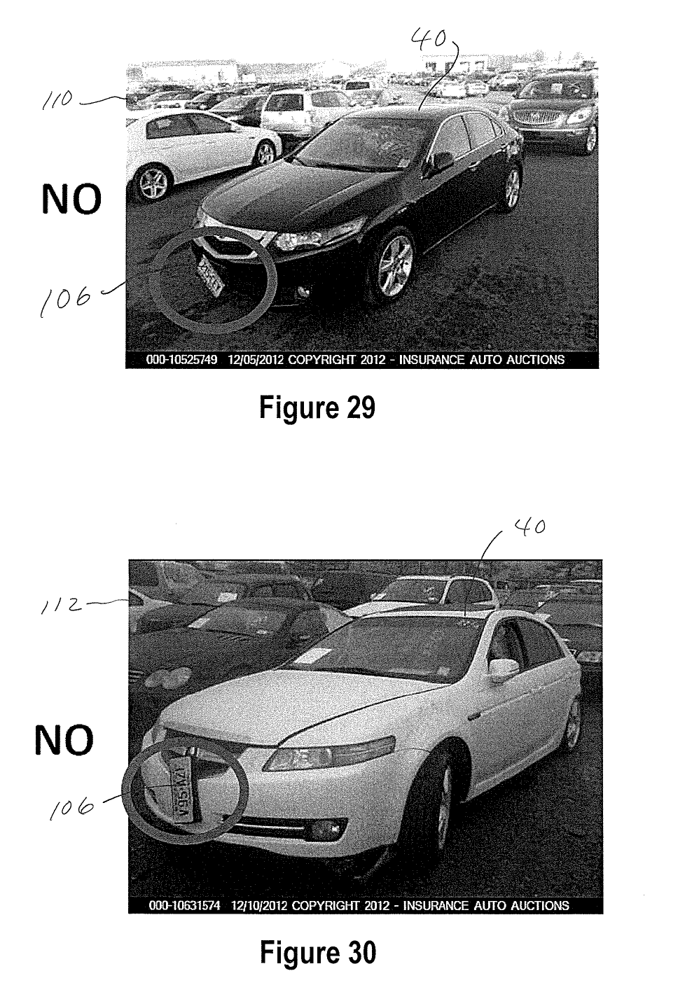

Other problems may occur which make the photograph unacceptable. It is undesirable that owner identifications should appear on the vehicle. For instance, the license plate of the vehicle should not appear in the photographs. Under the other problems category is an indication that the images appear out of sequence, or that some of the standard images are absent. For instance, in FIG. 28, the vehicle 40 has a license plate 106 in the image 108. The reviewer should reject this image using the other problem command 30. License plates 106 are also visible in the images 110 and 112 of FIGS. 29 and 30.

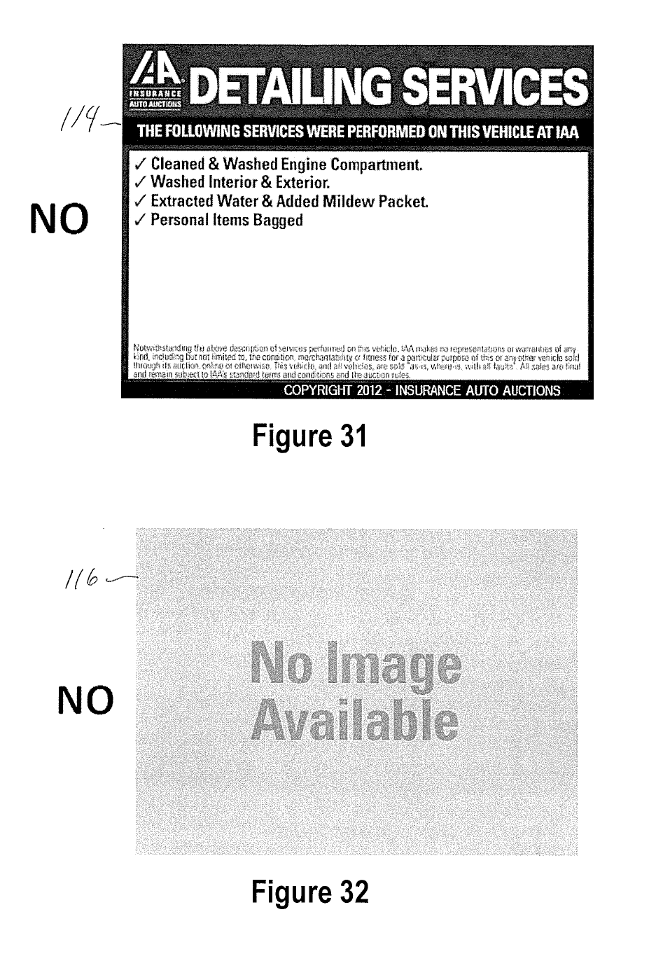

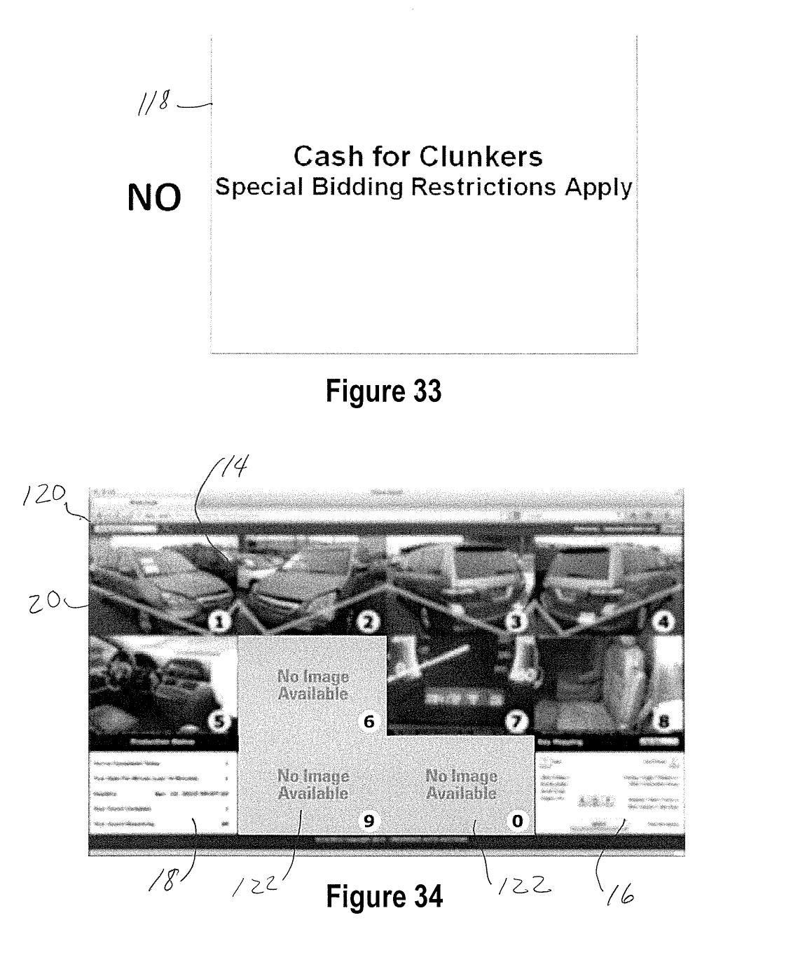

In FIG. 31, a graphical message 114 relating to a cleaning service that was performed on the vehicle appears in place of one of the standard photos. The absence of the standard image is the reason that the reviewer should reject this photograph 114 under the other category 30. Similarly, the image 116 of FIG. 32 simply states that no image is available for the corresponding standard photo. The reviewer should reject this photo under the other command 30. In image 118 in FIG. 33, a message to the bidders of the auction relating to bidding restrictions is presented in place of one of the standard photos in the grid 14. This is photo grid 14 should be rejected by the reviewer using the other command 30.

FIG. 34 shows a screen shot 120 of the grid 14 of the ten standard images along with the two reviewer guide images 16 and 18. Here, the virtual parking space lines 20 are overlaid on the first four photos of the standard set. The images for standard images 6, 9 and 10 (0) are missing as indicated by the graphical message stating “no image available.” The reviewer should reject this grid 14 using the other command 30.

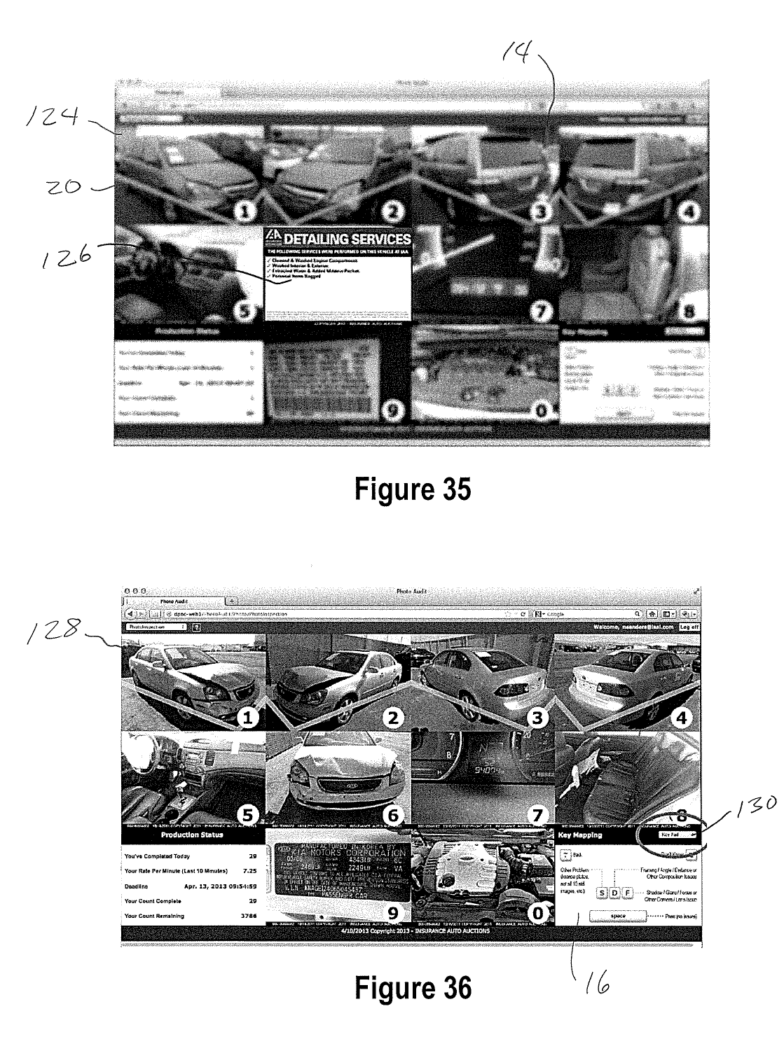

FIG. 35 shows a screen shot 124 of the photo grid 14 with a message image 126 in place of image 6 of the standard images. The non-standard image 126 is the reason that the reviewer should reject the images under the other code 30. The presence of duplicate images in the image grid 14 is also a reason for rejecting the images under code 30.

If the reviewer is unsure as to whether the images presented in the grid 14 are acceptable or not, the user may select the “do not know” command 32. Situations where the “do not know” command 32 has been used by reviewers may provide an opportunity to improve the instructions used to train the reviewers, as well as to address other issues with the review process.

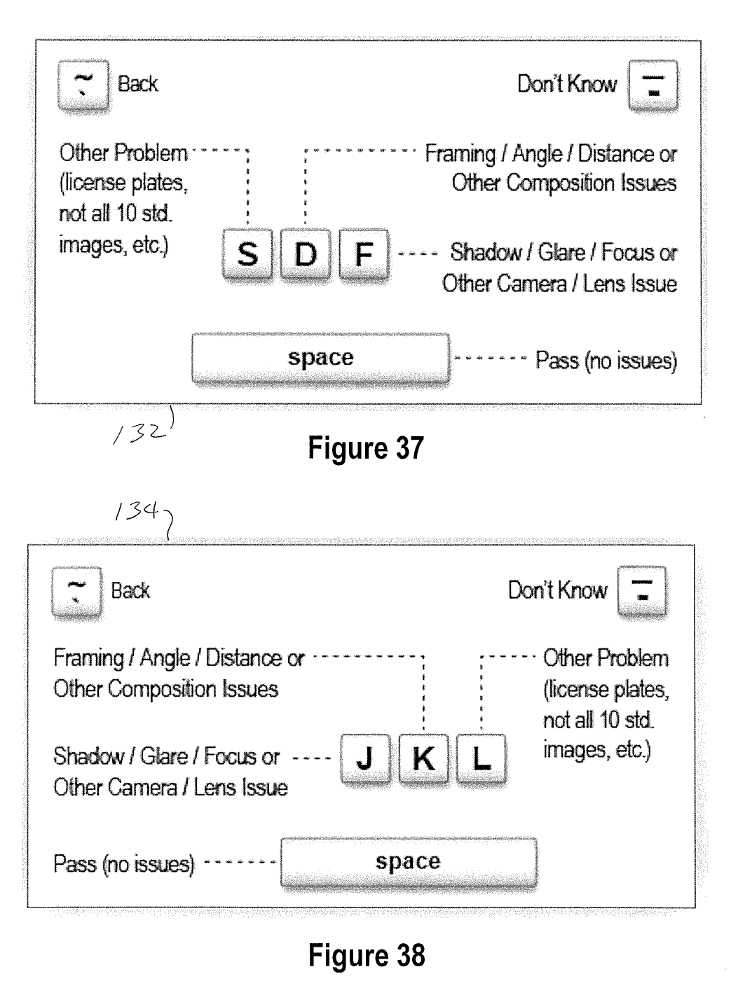

In the screen shot 128 of FIG. 36, the grid 14 of ten standard images is presented for the reviewer to grade. The key mapping portion 16 of the screen 128 is provided to show the reviewer the keyboard commands for entering the various review codes. A pull-down selector 130 is provided in the key mapping portion 16 that enables the reviewer to select from two or more possible key arrangements for entering the review commands. In a basic version, the user may select a left hand set of keys or a right hand set of keys. Depending on user preference and the computer setup, other key arrangements may be possible as well. FIG. 37 shows a graphic 132 of the left-hand keystrokes for rating the photos of the standard photo grid. FIG. 38 shows a graphic 134 of the right-hand keystrokes to be used by the reviewer. The significance of these keystrokes is explained in the foregoing and is not described further here.

Entry of a keystroke rating for the displayed grid 14 of photos causes the photos of the displayed vehicle to disappear from the computer screen and a next grid of photos of a next vehicle to be displayed. As such, the reviewer need only enter one keystroke for each displayed grid. The review can thereby proceed very quickly using the single keystroke rating entry, so that a large number of vehicles may be reviewed in a short time. This speed can be important, particularly where the number of vehicles to be reviewed numbers into the tens of thousands, hundreds of thousands, or even millions.

The use of a computer mouse or other pointing device is avoided in the preferred embodiment since a computer pointer device often requires that the user move a hand from the keyboard to the mouse, and then back to the keyboard, and may require that the user move the gaze of their eyes from the display screen to locate the proper hand positions. This extra effort slows the review process and is avoided by the choice of keys that are located at positions under a user's fingers.

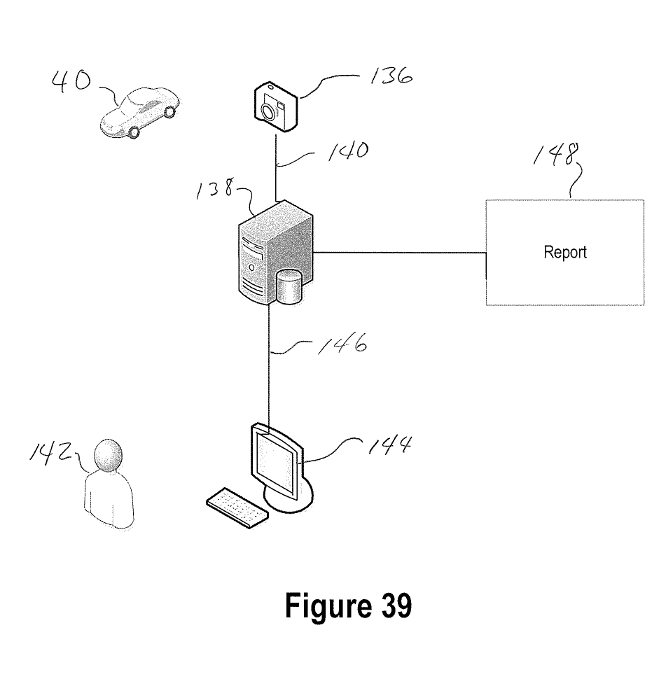

FIG. 39 is a schematic diagram of the system used to rate the vehicle photographs. A vehicle 40 is photographed by a photographer using a camera 136. The objective of the photographer is to take the ten standard photographs of the vehicle as described herein. Of course, more or fewer photographs may be used as a standard set. The photographs taken by the camera 136 are transferred to a server 138 by a communication link 140. The communication link 140 may be a connection of the camera to the server after the photographs are taken, such as by connecting a cable to the camera. The communication link 140 may include wireless communication, for example, as the photographs are being taken or following the taking of the photographs. The communication link 140 may include a photo card reader that reads a photo memory card of the camera for transfer of the photos to the server 138. The communication link 140 may include a network connection, an Internet connection, or other means for transfer of the images from the camera 136 to the server 138.

The camera 136 of one embodiment is a digital camera, which can be a dedicated camera or a multi-function device, such as a camera phone, a smart phone or table computer or other multifunction device. The camera 136 may be an SLR camera, a mirrorless camera, a point-and-shoot camera, or other camera type. A video camera, web cam, or other type of video recording means may also be used, particularly if it is capable of recording still images as well. It is within the scope of this invention that video images and/or video segments may be provided to show the vehicle. The video images may be reviewed according to the principles of the present invention as well. If a film camera is used, the communication link 140 may include film processing and transfer of the images from the film to the server, such as by scanning. A plurality of photographers may be hired to use a plurality of cameras 136 to photograph a plurality of vehicles 40. The vehicles 40 may be located together or at distributed locations. The photographs may be taken in a short period of time, or may be collected over a longer period of time.

The server 138 to which the images are transferred may include any of a variety of computer devices, including database servers, desktop or laptop computers, or other computers, computer devices, and/or computer readable storage means. The server 138 may represent a computer system, such as a networked computer system having a number of computers. Also within the scope of this invention is the use of cloud storage for the images, or other off-site and/or distributed storage.

A reviewer 142 uses a computer 144 to view the images. The computer 144 may include a desktop computer, laptop computer, tablet computer, smart phone, workstation or other computer device capable of displaying the images to the reviewer 142. The computer 144 of one embodiment includes a web browser that is used to retrieve and view the images from the server 138 via a communication link 146. The communication link 146 may be a network or the internet and may be provided to the reviewer's home, business, office, or other location. The server 138 includes a web server that provides the images formatted for viewing by the web browser. In an exemplary embodiment, the images are formatted in the grid 14 as shown for example in FIG. 1. The server retrieves the ten standard photographs of the vehicle (when available) and presents them in the grid 14. The server 138 receives and stores the ratings of the reviewer 142 for reporting. In a preferred embodiment, a plurality of reviewers 142 use a plurality of computers 144 to review the images taken by the photographers. Some of the images being reviewed are being reviewed for a first time, and others have been reviewed before, for example, as a check of the reviewer skill.

The server 138 may generate a report 148 of the photo review. The report 148 may be used to determine which vehicles 40 need to be photographed again to obtain conforming photographs. The report 148 may be used to evaluate the skill or performance of the photographers. The report 148 may be used to evaluate the cameras 136 or other equipment being used to take the photographs. For instance, it may be determined from the ratings that the photographers should be provided with cameras with a wide angle lens, with a filter that protects the lens from dirt and smudges, or cameras with a higher contrast imaging system. The report 148 may be used to compare the images of one location or branch office of the company to another location or branch office, by comparing the pass/fail ratio of the branches.

Applicants currently understand that better quality photographs generally result in a higher average price for auctioned vehicles. This understanding can be tested by having photographs of vehicles that have already been auctioned reviewed using the present review process and comparing the grade report of the vehicles to the auction prices. A determination can be made as to which factors or issues in the photographs have the greatest impact on sale price of the depicted vehicle by comparing auction prices to ratings for different photographic problems. A rated set of photographs of vehicles can be compared to the auction price returned by the vehicles to determine if those which received a passing grade sold for a better price than those that received a failing grade.

A vehicle auction in which all the vehicles being sold are shown in a complete set of clear and properly aligned photographs will be more appealing for the bidders at the auction. A vehicle auction in which the vehicles are well presented will be appealing to the insurance companies, who seek the highest possible prices for the damaged vehicles.

With the present system and method, it is possible to evaluate photographers and collections of vehicle photographs, regardless of the source of the photographs. Comparisons can be made between sets of photographs.

The present system and method is not limited to photographs of vehicles, but may be applied to photographs and/or images of many other objects. For example, a seller of new products may seek a review of the photographs to be used in a catalog, where each item is represented by several photographs. A reviewer can quickly determine whether views are missing or whether the photographs have issues, even for catalogs containing large numbers of products. A seller of used objects may use the teachings of the present invention to provide clearer, better oriented photographs of the used items. Operators of on-line auction sites may wish to use the present review method and system to verify that the photos of items being sold for auction meet site guidelines, for example. Many other uses are possible, as will be understood by those of skill in the art.

It is contemplated to provide the cameras or other photographic devices used to take the photographs with the virtual parking lines overlay or other guides to ensure that the vehicle or other subject is aligned in the desired position in the vehicle frame.

Thus, there is shown and described a system and method for review of photographs to determine if the photographs are clear and well composed. A set of photographs is presented to a reviewer who determines whether photographs comply with certain requirements. Subject location overlays may be provided on some of the photographs to assist the reviewer in determining whether the photographs meet the requirements. A simple and fast way of entering the reviewer's comments and moving on to a next set of photographs is provided. This is particularly applicable to vehicle auctions but may be used for evaluating other photographs as well.

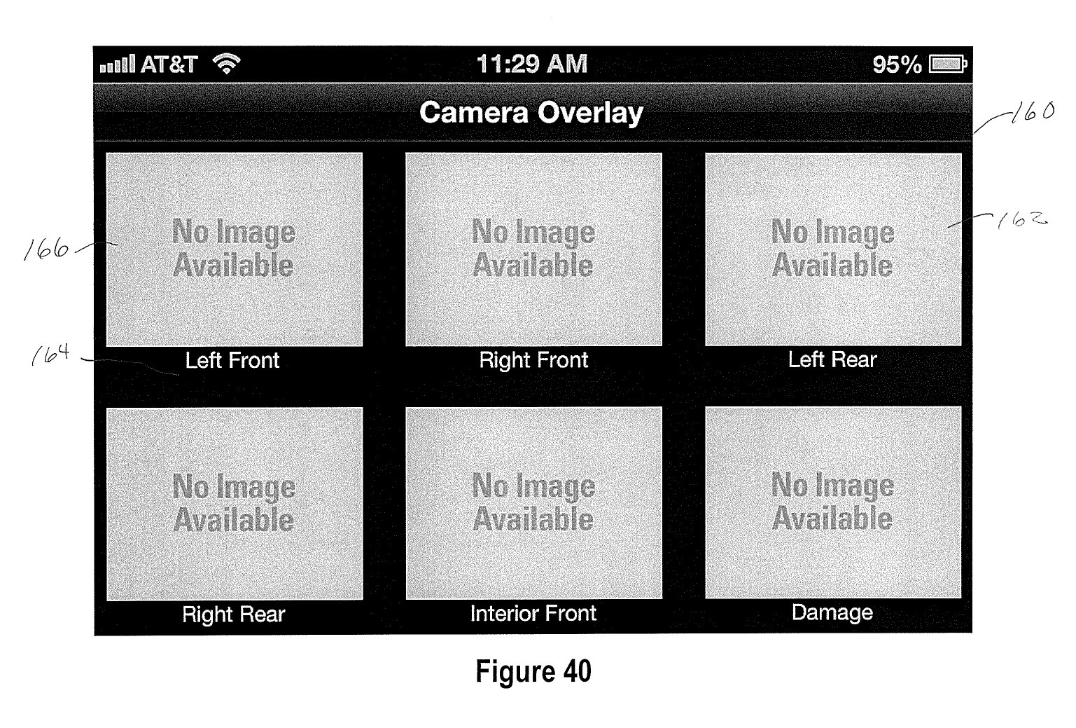

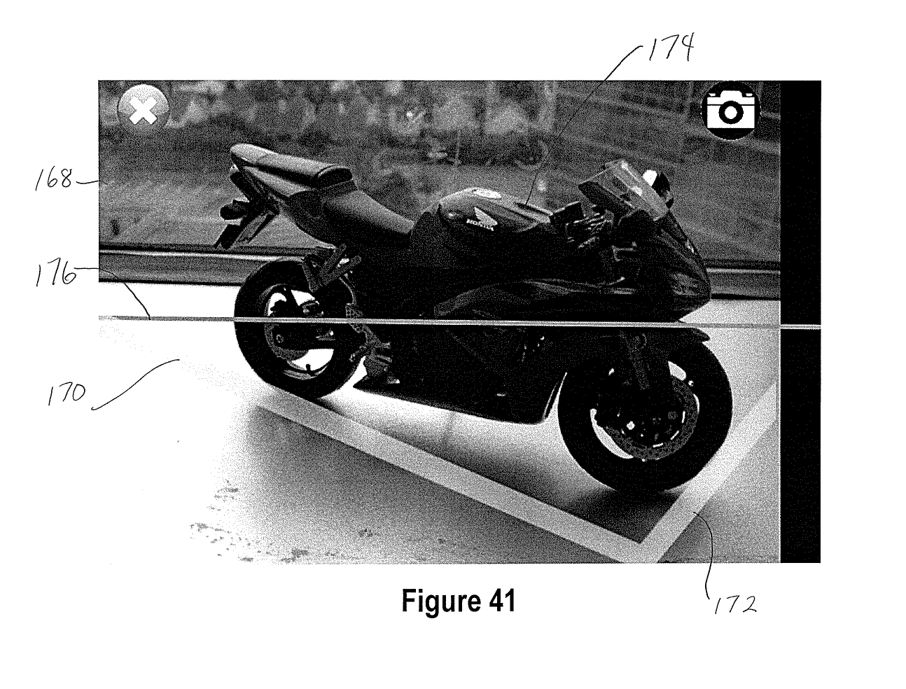

Also provided is a method and system for assisting a photographer in orienting and positioning a subject within a photograph to comply with certain requirements and guidelines. In FIG. 40, an app, or application, 160 is provided for an imaging system. The imaging system may include a tablet computer, camera-phone, smart phone, camera, or a camera connected to a computer device. The app 160 displays a grid 162 of overlays for use when photographing a subject, such as a damaged vehicle. The grid 162 includes directions 164 as to the orientation and order of the photographs to be taken. For instance, the first image to be taken is from the left front of the vehicle. This direction 164 is below a cell 166 of the grid 162 where the photograph will be displayed after being taken using the app 160. Other orientations in this example include right front, left rear, right rear, interior front, and damage. Of course, fewer or more orientations may be provided, as well from other directions.

In FIG. 41, a viewfinder 168 of a camera device or a live view from the camera on a connected computer device shows an object 174 being photographed. In this example, the object is a motorcycle. The viewfinder or other view includes yellow parking space lines 170 and 172 overlaid on the image as a guide to orienting the vehicle in the photo. The parking space lines include a longer line 170 to be arranged along the side of the vehicle, and a shorter line 172 to be arranged at the front, in this view, of the vehicle 174. The photographer is able to see these lines as the photograph is being taken and so is able to align and orient the subject in the image. It is also possible that the parking space overlay could be provided prior to the photograph being taken and/or after the photograph is taken. If displayed after the photograph is taken, the photographer can immediately evaluate the alignment of the photograph and retake it if necessary.

Also in the image 168 is a horizontal indicator line 176. The indicator line 176 aids the photographer in determining the angular orientation of the horizon line or other horizontal features in the photograph. While horizontal orientation may be a simple matter in taking most photographs, a landscape for instance, the photographer is regularly photographing vehicles arranged at angles in the images, which may distract the photographer from achieving a horizontal alignment of the image.

In a preferred embodiment, the horizontal line 176 indicates whether the image is being taken at the proper orientation. Here, the line 176 is green when the camera is sensed to be horizontally oriented. The photographer may take the photo after seeing the green horizontal line 176 and the subject within the guidelines 170 and 172. The parking space lines and horizontal indicator line may be turned on and off by the photographer, or “blinked” to permit a clear view of the final image while still providing guidance.

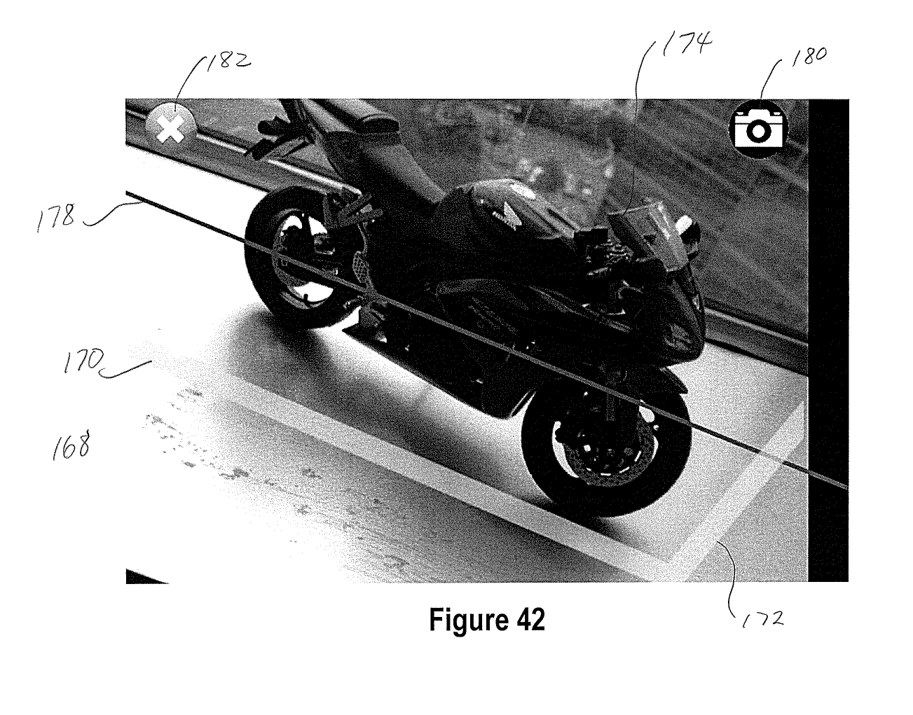

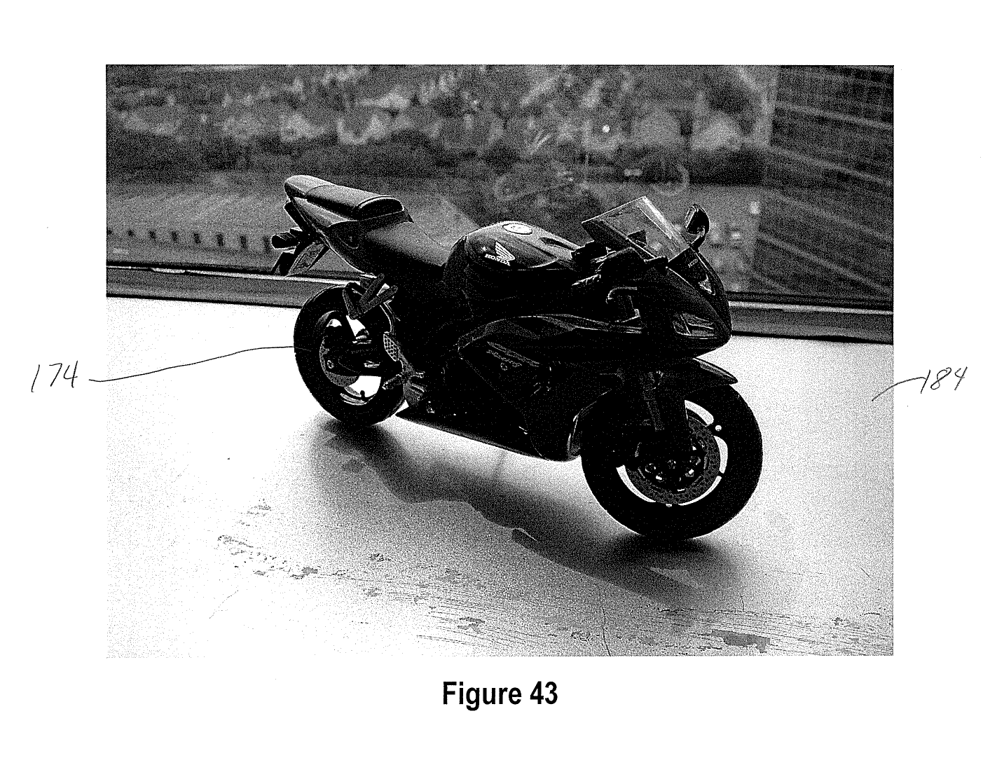

FIG. 42 shows the viewfinder 168 of the camera device with the vehicle 174 aligned within the parking lines 170 and 172 and a horizontal indicator line 178 to show the horizontal orientation of the camera. The camera has been tilted at an angle when the photograph in FIG. 42 is taken, which is indicated by the angle of the line 178 within the photo frame. In addition, the line 178 changes color from green to red when the camera angle departs significantly from horizontal. The image of FIG. 42 is oriented correctly for the parking space, but is not oriented horizontally. In addition, the back of the vehicle 174 is cut off by the image frame. This photograph would be rated as unacceptable if rated by a reviewer. Seeing this, the photographer has an opportunity to take another photograph at the proper angle and orientation.

Camera control icons 180 and 182 are shown in the images of FIGS. 41 and 42. Touching these icons take a photograph or exit the imaging program.

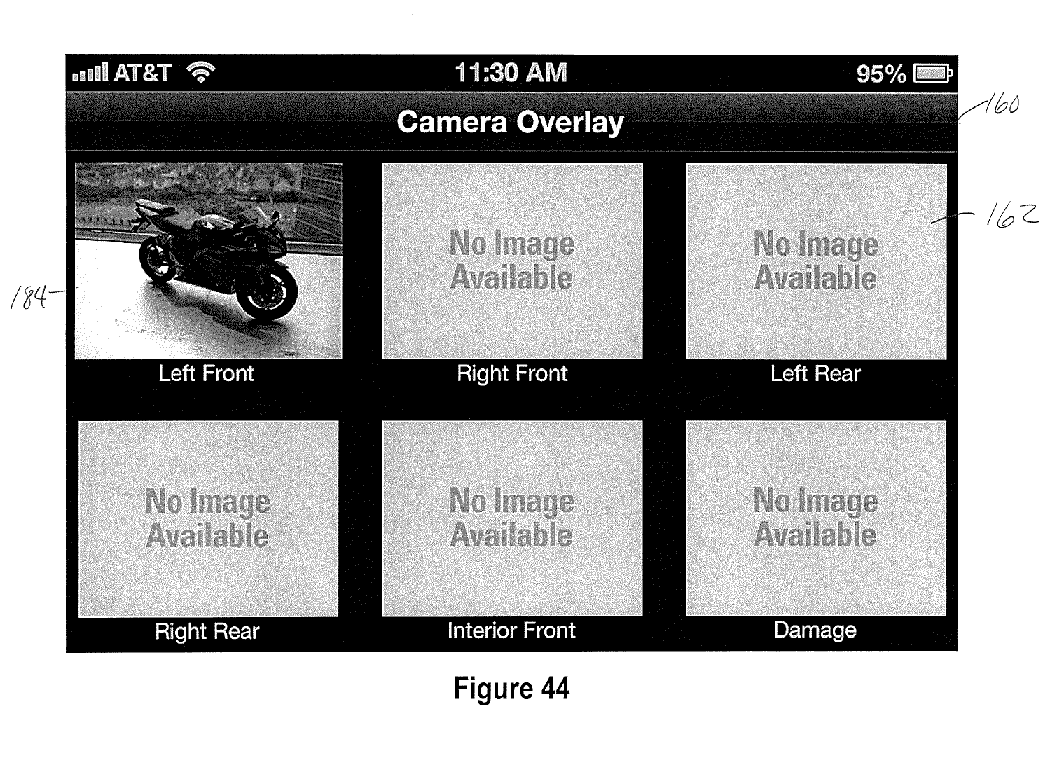

FIG. 43 is a photograph 184 of the vehicle 174 that has been taken using the parking space lines 170 and 172 and the horizontal indicator line 176. These lines are not visible in the final photograph. The lines are not saved with the saved image file, or may be saved but remain in a hidden mode until selectively displayed. In FIG. 44, this photograph 184 is inserted into the grid 162 of the app 160 at the cell for the corresponding orientation. The photographer is then guided in taking the next orientation by an overlay of parking lines and a horizontal line for the right front view. Each view may be provided with orienting lines, if desired. Or, some views may be provided with orienting lines for the photographer and others may not have such lines. The different views are automatically ordered in the proper sequence by following the grid of the app.

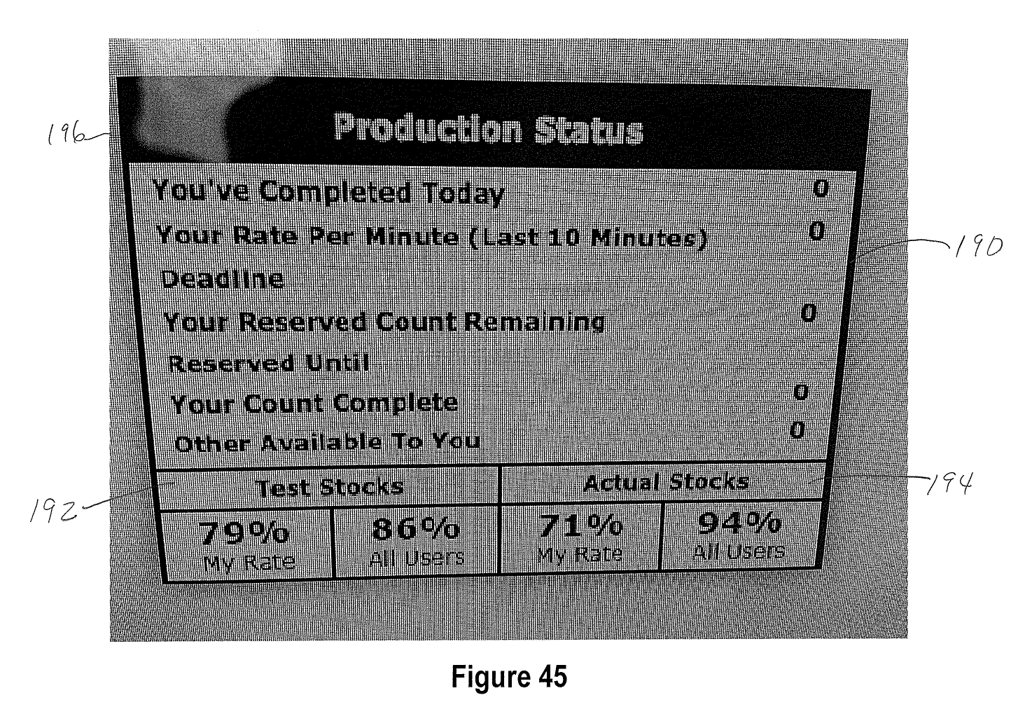

Turning to FIG. 45, the reviewer of the images may be required to meet certain production criteria, such as to review a particular number of photograph sets within a particular time frame. A reporting function may be provided that monitors and reports the number of image sets reviewed in a dialog box 190. The reporting box 190 not only reports on the review rate and completed/uncompleted count, but it also reports on the reviewer's performance on test image sets that are included in the mix of image sets to be reviewed. When a determination is to be made as to whether the reviewer is accurately rating the photographs, sets of photographs that have already been rated by others are presented to the reviewer, either alone or mixed with images that have not been reviewed. The ratings assigned by the reviewer are compared to the ratings assigned by other reviewers.

For example, in the reporting box 190, the reviewer is rating test stocks 192 of photos at 79 percent agreement to the previously assigned ratings. The average of other reviewers is in agreement on 86 percent of the images. For actual stocks 194 of images, this reviewer is passing 71 percent of the image sets. The average of all users is 94 percent passing rate. This user has departed significantly from the average of the users in judging whether the images meet the standards.

The production status 196 for this user reports the number of image sets reviewed today, the rate per minute, the deadline for review of the project, the reserved counts remaining, the date on which reserved set is reserved until, the count of completed sets, and the other sets that are available to the reviewer. The reviewer is thereby able to track his or her review performance and compare it to others. These numbers are also monitored by the company so that the reviewer's performance is known.

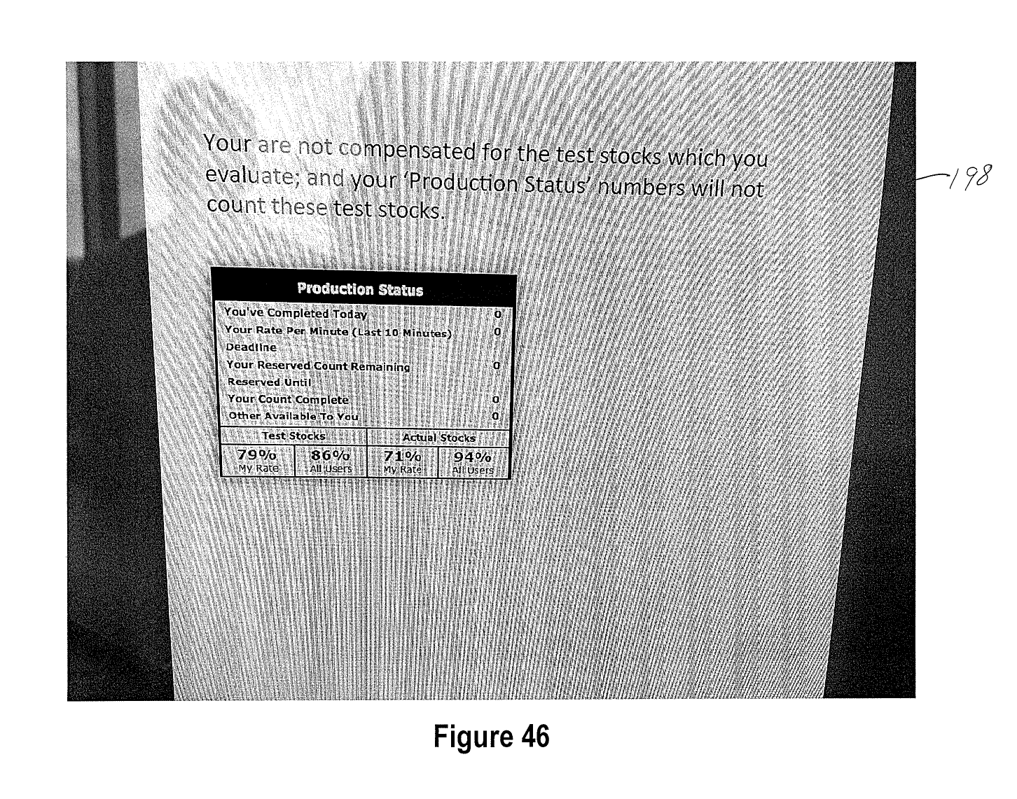

The screen shot 198 of FIG. 46 shows an informational screen shown to a reviewer that informs the reviewer that they are not being compensated for reviews of test stocks which the reviewer evaluates, and that the production status numbers do not count the test stocks in the reported totals. Other informational screens may be provided as well.

Thus, the present invention also provides guidelines to photographers when taking photographs so that the photographs will comply with orientation requirements.

Although other modifications and changes may be suggested by those skilled in the art, it is the intention of the inventors to embody within the patent warranted hereon all changes and modifications as reasonably and properly come within the scope of their contribution to the art.

We claim:

1. A system for evaluating photographs of items, comprising:
a server computer device having stored thereon a plurality of photographs of the items;
a reviewer display of a computer device connected to receive predetermine ones of the photographs of the items, the reviewer display being operable to display the photographs as sets of photographs wherein each set comprises photographs of a single item, the reviewer display displaying simultaneously a plurality of photographs of the single item of the set at a time;
a virtual alignment element displayed on the reviewer display as an overlay on predetermined ones of the photographs of each set;
a user input of the computer device configured to receive a single keystroke rating from a reviewer, the single keystroke rating corresponding to the reviewer's rating of the set of photographs being displayed on the computer device, the reviewer computer being operable to transmit the single keystroke rating to the server computer device for storage, the computer device causing the reviewer display to display a next set of photographs following receipt of the single keystroke rating of the displayed set, the single keystroke input including as a possible input a keystroke relating to alignment between the virtual alignment element and the item appearing in the photograph; and
a report output of the server computer device for generating a report of sets of the photographs that received either a passing rating or a fail rating.

2. A system as claimed in claim 1, further comprising:
a camera operable to photograph a plurality of the items, the camera being selectively connectable to the server computer device to thereby transfer photographs of the items to the server computer.

3. A system as claimed in claim 2, wherein the camera is operable to re-photograph the items which are shown in photographs receiving a fail rating.

4. A method for evaluating photographs of an item being offered for auction, comprising:
displaying a plurality of the photographs of a first item as a set on a display screen for review by a reviewer, the photographs of the set being displayed in a standardized arrangement having predetermined views of the first item in each corresponding position of the standardized arrangement;
overlaying an alignment image on predetermined ones of the photographs in the standardized arrangement;
receiving from a reviewer a rating of the photographs of the set of the first item, the rating being received as a single keystroke entered on a keyboard by the reviewer;
following the receiving of the rating of the set of the first item as a single keystroke, displaying a plurality of the photographs of a second item on the display screen, the photographs of the set of the second item being displayed in the standardized arrangement with the predetermined views of the second item in the same corresponding positions of the standardized arrangement as for the first item; and
repeating the displaying, overlaying and receiving steps for subsequent items.

5. A method for evaluating a quality of a set of photographs, comprising:
displaying a plurality of photographs of an item in a predetermined arrangement of views of the item;
overlaying an alignment image on predetermined ones of the photographs; and
receiving an evaluation of whether the item in at least one of the photographs is substantially aligned with the alignment image of the overlay.

6. A method for evaluating a plurality of photographs of a plurality of items, comprising:
receiving a plurality of photographs of each item for a plurality of items;
displaying the plurality of photographs of a first item together as a set on a display screen in a predetermined arrangement of views of the first item;
receiving a rating of one of a pass and fail for the set of photographs of the first item;
displaying the plurality of photographs of a second item together as a set on a display screen in a predetermined arrangement of views of the second item;
receiving a rating of one of a pass and fail for the set of photographs of the second item;
continuing the displaying and receiving the rating for subsequent items; and
transmitting an instruction to obtain new photographs of the items that received a fail rating.

7. A method as claimed in claim 6, wherein the fail rating comprises a plurality of ratings corresponding to different issues with at least one of the photographs of the set.

8. A method for orienting an object in a photograph, comprising:
displaying a preview image of a photograph to be taken;
overlaying on the preview image an alignment image that depicts a desired orientation and position of the object in the photograph;
capturing the photograph of the object; and
saving the captured photograph without saving the alignment image.

9. A method as claimed in claim 8, further comprising:
overlaying a horizontal orientation indicator on the preview image with the alignment image.

10. A method as claimed in claim 8, further comprising:
displaying the photograph for evaluation; and
overlaying the alignment image on the displayed photograph during the display for evaluation.

11. A method as claimed in claim 8, further comprising:
displaying a guide to a plurality of orientations of the object within photographs of the object;
overlaying a plurality of alignment images on respective sequential preview images;
capturing a sequence of photographs in accordance with the sequential preview images; and
displaying the sequence of photographs in order on a display.
